(19) United States
(12) Patent Application Publication
(10) Pub. No.: US 2013/0093830 A1
(43) Pub. Date: Apr. 18, 2013

(54) SYSTEMS AND METHODS FOR ACCEPTING VIDEO CALLS ON VOICE TELEPHONES AT CALL CENTERS OR OTHER LOCATIONS

(71) Applicant: NEXTALK, INC., South Jordan, UT (US)

(72) Inventors: Kim Richardson, Holladay, UT (US); Gary Bowen, Draper, UT (US); Chau T. Tran, Midvale, UT (US)

(73) Assignee: NEXTALK, INC., South Jordan, UT (US)

(21) Appl. No.: 13/652,031

(22) Filed: Oct. 15, 2012

Related U.S. Application Data
(60) Provisional application No. 61/547,564, filed on Oct. 14, 2011.

(51) Int. Cl. H04N 7/14

(52) U.S. Cl. 348/14.01; 348/E07.077

(57) ABSTRACT

A method for providing video-based communication between an originating user and a recipient located within a call center includes a server receiving an originating live video call, the server holding the live video call, the server generating a placeholder call corresponding to the live video call, and the server transmitting the placeholder call through the network to the call center. The method may also include the call center determining if an agent with video call capability is available, and if an agent with video call capability is available, the call center transmitting the placeholder call to the available agent within the call center, the call center generating a video link and transmitting the video link to the server, the server receiving the video link, and the server matching the video link to the live video call to establish communication with the agent.

### CROSS-REFERENCE TO RELATED APPLICATION

This application claims the benefit of the filing date of U.S. Provisional Application No. 61/547,564, filed Oct. 14, 2011, and entitled SYSTEMS AND METHODS FOR ACCEPTING VIDEO CALLS ON VOICE TELEPHONES AT CALL CENTERS OR OTHER LOCATIONS, the disclosure of which is incorporated, in its entirety, by reference.

### TECHNICAL FIELD

The present disclosure relates to communication systems and more specifically to systems and methods for accommodating video communications.

### BACKGROUND

The plain old telephone system (POTS) or public switched telephone network (PSTN) has been in development since the late 1800's. In general, the term PSTN may mean any medium of communication in which at least part of the link is analog, and not digital, in nature. The PSTN was first developed to allow for person-to-person communications by voice over long distances. The PSTN was designed for calls between people who may both hear and speak, and was designed to handle voice sounds.

Deaf and speech impaired persons cannot readily use the PSTN to place or accept standard voice calls. In the 1960's TTY, or TDD, was designed and adopted by many deaf persons. The TDD is a type of modem and is a “text telephone” which may send typed text characters across the PSTN. TDDs encode text characters with a five-bit Baudot code, while most modems and desktop computers in the United States today use an ASCII encoding, also known as the ANSI X3.4-1977 or ASCII-77 encoding. TDDs transmit/receive at 45.45 bits per second and use frequency shift keying modulation/demodulation at frequencies of 1400 and 1800 Hz. TDD callers are not able to communicate directly with voice telephones and will often use a relay service. The relay service provides an operator who receives the text call and provides a voice read of the text. Relay services are effective, but substantially slower than real time text communication.

Video conferencing has become a popular method of communication between users. Video conferencing includes both audio and video components. That is, a video call between parties provides for audio and video communications between users. In terms of hardware, a user simply needs a display device, a speaker, an image sensor and a microphone, in order to simultaneously conduct a video call with one or more parties. The display device itself may be any type of display, including but not limited to a television (TV), a computer monitor, etc. In order to facilitate a video call, a display device is used to show one or more parties to the call. For example, in a video conference between two people, the image of each party is captured by their respective image sensors, and the display device on each party's side shows an image of the other party, or alternatively, shows images for both the caller and the called party. Similarly, each party to the call speaks into their respective microphones, whereupon the respective speakers play the conversation so that each party may hear the audio portion of the call.

Many people have access to desktop and laptop computers that are in communication with the Internet and may easily support text and video communication. There are also new types of devices that support text and video communication such as alpha pagers, wireless devices, smart phones, and other Internet capable devices. Most organizations today do not support TDD calls or video calls. TDD and video calls are not recognized as voice calls and require separate hardware and software to be properly handled by the organization. Thus, incoming TDD and video calls may not be received or may be cutoff prematurely.

It would, therefore, be advancement in the art to provide systems and methods for notifying a voice telephone of an incoming text or video call and provide text and video communication.

### SUMMARY

According to at least one embodiment, a method for providing video-based communication between an originating user and a recipient located within a call center includes a server receiving an originating live video call, the server holding the live video call, and the server generating a placeholder call corresponding to the live video call, wherein the placeholder call is a voice call. The method also includes the server transmitting the placeholder call through the network to the call center, the call center transmitting the placeholder call to a voice telephone to notify a recipient of the live video call, and generating a unique user code that identifies the recipient. The method further includes the server receiving the user code and the server sending the live video call to the recipient based on the user code to establish communication.

The user code may be based at least in part on a skill set of the recipient. The recipient or the call center may generate the user code. The call center may include a controller that routes calls to recipient employees of the call center, and the controller generates the user code. The skill set may include a non-English language. The user code may be based at least in part on video call equipment available to the recipient. The method may include the recipient answering the placeholder call and confirming availability to receive the live video call.

According to another embodiment, a method for providing video-based communication between an originating user and a recipient located within a call center includes a server receiving an originating live video call, the server holding the live video call, the server generating a placeholder call corresponding to the live video call, and the server transmitting the placeholder call through the network to the call center. The placeholder call passes a code for the live video call to a computer interface of the agent, the computer interface uses the code to retrieve the live video call from the server, and the server establishes communication with the agent.

The method may also include the call center engaging a video device to receive communication. If an agent with video call capability is not available, the call center may transmit the placeholder call to a voice phone, and the call center may generate a voice link and transmit the voice link to the server. If an agent with video call capability is not available, the call center may place the live video call in a queue until an agent with video call capability becomes available.

Another embodiment relates to a method of routing non-voice communication within a call center. The method includes receiving an incoming non-voice call, coding the non-voice call with coding representing at least one of a text communication, a video communication, and a language, communicating the coded non-voice call to the call center, and routing the coded non-voice call to an agent of the call center based on the coding.

The non-voice call may be a video call and the coding represents a language to be translated by an agent of the call center. The method may include generating a placeholder call that represents the coded non-voice call. The method may include determining if the call center has an agent available to take the coded non-voice call. The non-voice call may be a video call, and the method may further include determining if the call center has an agent available for the video call, and if not, creating a voice call link between the video call and an agent of the call center. Determining if a call center has an agent available may include determining if an agent having video call capability is available. The coding may represent both video communication and a language.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating aspects of the present disclosure.

FIG. 2 is a block diagram illustrating a system of the present discloses.

FIG. 3 is a block diagram illustrating an alternative embodiment of a system of the present disclosure.

FIG. 4 is a flow diagram illustrating a method in accordance with the present disclosure.

FIG. 5 is a flow diagram illustrating another method in accordance with the present disclosure.

FIG. 6 is a flow diagram illustrating another method in accordance with the present disclosure.

FIG. 7 is a block diagram illustrating a call center for use with the present disclosure.

FIG. 8 is a block diagram illustrating another system of the present disclosure.

FIG. 9 is a block diagram depicting a computer system suitable for implementing the present systems and methods; and

FIG. 10 is a block diagram depicting a network architecture in which client systems, as well as storage servers (any of which may be implemented using computer system), are coupled to a network.

### DETAILED DESCRIPTION

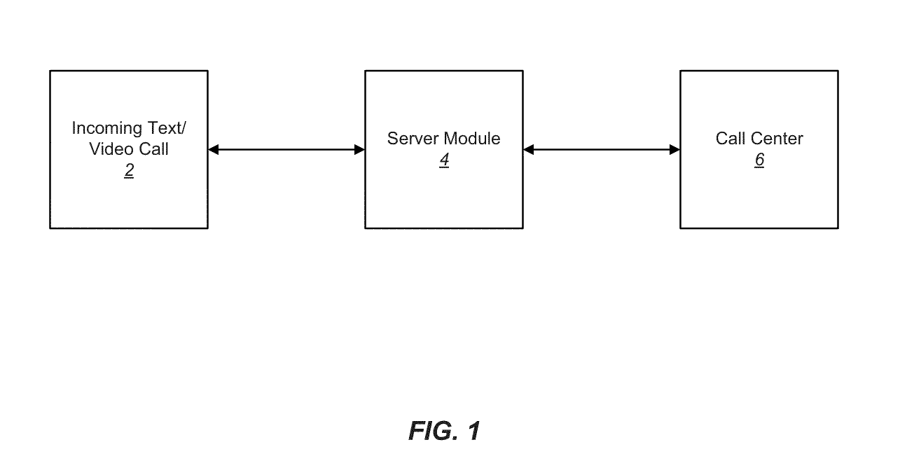

The presently preferred embodiments of the present disclosure will be best understood by reference to the drawings, wherein like parts are designated by like numerals throughout. It will be readily understood that the components of the present invention, as generally described and illustrated in the figures herein, may be arranged and designed in a wide variety of different configurations. Thus, the following more detailed description of the embodiments of the apparatus, system, and method of the present disclosure, as represented in FIGS. 1-10, is not intended to limit the scope of the invention, as claimed, but is merely representative of presently preferred embodiments of the present disclosure.

Referring now to FIG. 1, the present disclosure relates to systems and methods that involve communications using incoming text and video calls 2, a call center 6, and a server module 4, which interfaces between the calls 2 and the call center 4. The description that follows focuses primarily on video calls. Details concerning handling of text calls in a similar context are provided in U.S. Pat. No. 7,555,521, which is incorporated herein in its entirety by this reference. The systems and method disclosed herein may be compatible with text calls alone, video calls alone, or a combination of text and video calls. The text and video calls may be linked with voice calls as part of providing communication with, for example, a call center.

One aspect of the present disclosure relates to handling an incoming video call 2 at a call center 6. The server module 4 receives the video call 2 and codes the video call 2 based on information related to the video call 2. The coded video call 2 is routed to an agent of the call center 6 based on the assigned coding. The coding may relate to, for example, the language being spoken (e.g., American Sign Language (ASL) or a non-English language) or a translation language of the video call (e.g., translation from Spanish to English, etc.).

The server module 4 may use a placeholder call, which is directed to the call center and represents the incoming video call 2. The placeholder call may carry the coding assigned to the incoming video call 2. The call center 6 may use the coding of the placeholder call to identify which agent should handle the incoming video call. Criteria for selecting the proper agent may include, for example, language skills, equipment availability (e.g., video hardware and software), experience level, native language or country, and time availability. Once the agent is identified, the server module 4 links the agent to the incoming video call. The criteria may be weighted differently so that, for example, availability may be given greater weight than the years of experience or native language when selecting the agent.

In other arrangements, the server module 4 directly connects the incoming video call to the appropriate agent without using a placeholder call. In further arrangements, if there is no agent available with video call capability, the incoming video call 2 may be linked with an agent having only voice call capability. This may be referred to as a roll-over call or video-to-voice call.

The coding assigned by the server module 4 to an incoming text, video, or voice call 2 may relate to any desired amount or type of information associated with the incoming call. The coding may be used by the call center 6 as part of the call center's own system or software to maximize efficient use of its agents, agent skills and any specialized hardware/software needed for particular types of calls, such as text or voice calls in addition to voice calls.

In some arrangements, the agent identified for taking the incoming video call may input a code associated with the agent, and send that code to the server module 4 so that the server module 4 can connect the incoming video call to that agent through the call center. In other arrangements, a computer, through which the agent communicates, automatically generates a code associated with the agent and sends that code to the server module 4 as part of connecting the incoming video call with the agent.

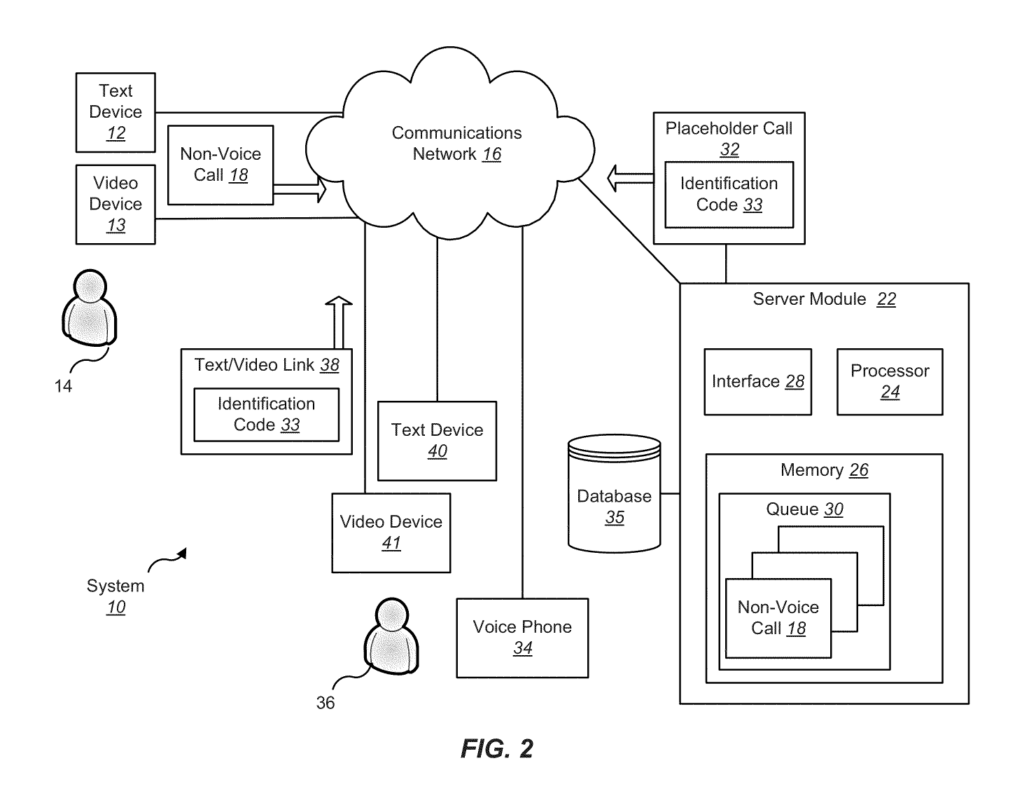

Referring to FIG. 2, a schematic block diagram of a system 10 for use with the present disclosure is shown. A text device 12 o r video device 13 generates a call that may be characterized as non-audio or a non-voice call that is interpreted visually by another user. The non-voice call may include, for example, alphanumeric text, graphics, video, audio, and other forms of signals that are legible, visible or audible.

The text device 12 may be a conventional TDD or TTY device or other such device that uses the text telephone standards. These standards include the TTY 45/50 bps Baudot in use in U.S., Canada, and Australia and the EDT (European Deaf Telephones) used in other countries. The video device 13 may be a video phone device or other such device that uses video call standards. The standards may include video conferencing standards used in the U.S. The text device 12 or video device 13 may also be a personal computer suitable for providing email, webchat, webcam, and other forms of communication. The text device 12 or video device 13 may also include, for example, a set top box, alpha pager, cellular telephone, or other device capable of generating text characters and video and interfacing with a communication network 16.

A user 14 of the text device 12 or video device 13 may wish to converse with a recipient who has a voice telephone, and it may not be possible for the user 14 to contact the voice telephone user directly. This is the case if, for example, the user 14 is hearing or vocally impaired, if the user 14 does not have convenient access to a voice telephone, or if the user speaks a different language.

The communication network 16 may be implemented in various ways including a PSTN or a wide area network (WAN) such as the Internet. There are various ways for a text device 12 or video device 13 to be coupled together and communicate through different embodiments of a communication network 16. Such methods are well known in the art. Upon coupling to the communication network 16, the text device 12 or video device 13 transmits a non-voice call 18.

Rather than transmitting the non-voice call 18 directly to a recipient, the non-voice call 18 is routed or transferred through the network 16 to a server module 22. In one embodiment, the network 16 may be a PSTN and the text device 12 may be a TTY compatible device. In this case, routing the non-voice call 18 to the server module 22 may be achieved in different ways. For example, the user 14 may dial a published TTY phone number or video call number and be directed to the server module 22 on a phone line or trunk.

In one implementation, the server module 22 extracts the phone number dialed from the non-voice call 18. The server module 22 maintains a list or a database 35 of participants corresponding to the dialed numbers. The number of a particular call will identify which participant is being called in this manner. The server module 22 may provide an initial text greeting to the user 14 that identifies the participant being called based on the number being called for the non-voice call 18.

The server module 22 may further extract the phone number of the calling party. This is common practice where the phone trunk is a digital trunk such as a T1 or PRI ISDN line. The calling party number may be sent to an intended recipient as explained below. Alternatively, the user 14 may call directly to an organization or entity. The person answering the non-voice call 18 may transfer the non-voice call 18 to the server module 22. Other means of routing or transferring a non-voice call 18 to the server module 22 are known in the art and are included within the scope of the present disclosure.

The server module 22 may include a processor 24 for performing aspects of the present disclosure. The processor 24 may be in communication with a memory 26 and a communication interface 28 for coupling with the network 16. The server module 22, on answering the non-voice call 18, may send some form of text greeting and a “please hold” message. The server module 22 may place the non-voice call 18 in a queue 30 that is resident in the memory 26.

The server module 22 may assign an identification code 33 or queue name to identify the received non-voice call 18. The identification code 33 allows specific identification of each received non-voice call 18 and is used to match the inbound non-voice call 18 with a recipient at a voice telephone as described below.

The server module 22 may generate a placeholder call 32 that is so named because the placeholder call 32 notifies a recipient of a held non-voice call 18. The placeholder call 32 may include an identification code 33 which corresponds to the pending non-voice call 18 held in the queue 30. The placeholder call 32 may further include other identifying information of the pending non-voice call to notify a recipient of the calling party number, which is also referred to as the origination number. The placeholder call 32 may be transmitted through the network 16 to a voice telephone or voice telephone system recipient 34 (also referred to herein as an agent 34).

The server module 22 may transmit the outgoing placeholder call 32 to a designated voice number of a participating entity. The server module 522 may ascertain the voice number in different ways. In the case of an incoming text call 18, the server module 22 may be used in a service bureau or other organization where multiple TTY numbers are supported on T1 or PRI trunks. If a TTY user dials one of these numbers directly, then the server module 22 may access a database 35. The database 35 may contain voice numbers of various organizations that are mapped to the TTY numbers. The server module 22 may then search and retrieve the voice number from the database 35 based on the DNIS/DID of the number dialed.

In some cases, the non-voice call 18 may arrive at a voice phone at an organization before arriving at the server module 22. A recipient answering the non-voice call 18 may transfer the non-voice call 18 to the server module 22. In this case, the server module 22 may retrieve information about the transferred non-voice call 18 and access the database 35. The server module 22 may map the call to a voice telephone 34.

A user 36, also referred to herein as a recipient or agent, receives the placeholder call 32 through the voice telephone 34. The recipient (e.g., user 36) may be an individual capable of hearing and/or seeing. The placeholder call 32 may contain voice or visual notification that a non-voice call 18 is pending in the queue 30. The placeholder call 32 may also contain an audio or visual message of the identification code 33 corresponding to the non-voice call 18. Alternatively, the identification code 33 may be resident in the placeholder call 32, but not as an audio or visual message for the recipient 36.

The placeholder call 32 may further include the other information (e.g., the ANI) of the calling party number to indicate the origination. Identifying the origination of a calling party may be useful in a number of commercial applications.

The recipient 36 may respond to the placeholder call 32 by generating a text or video link 38 by use of a remote text device 40 or video device 41. By responding to the placeholder call 32 with the text/video link 38, the server module 22 is able to match the text/video link 38 with the holding non-voice call 18. After matching or linking, a text or video conversation may then proceed. Thus, the system 10 relies upon a recipient 36 responding to the placeholder call 32 by sending a form of a text/video call to the server module 22.

The text device 40 may be similarly embodied as the text device 12. In one embodiment, the text device 40 may be a modem or a TDD/TYY compatible device. The video device 41 may be a video phone device or other such device that uses video conferencing standards. Alternatively, the text device 40 or video device 41 may be a personal computer with instruction code and suitable interface for text, graphic, video and/or voice communication over the network 16. The text device 40 and video device 41 may also be an alpha pager, set top box, cellular phone, and so forth. One of skill in the art will appreciate that the text device 40 and video device 41 may have various embodiments and these are included within the scope of the present disclosure.

The text/video link 38 may include the received identification code 33. The identification code 33 allows matching of the text/video link 38 with a non-voice call 18 in the queue 30. The server module 22 may also use a time-based system for matching non-voice calls 18. For example, the server module 22 may match the non-voice call 18 held the longest with an inbound text/video link 38. In this way, each non-voice call 18 does not need a separate identification code 33.

The recipient 36 may include the identification code 33 with the text/video link 38 by manually entering the identification code 33 into the text device 40 or video device 41. In an alternative embodiment, the voice telephone 34 and the text device 40 or video device 41 may be integrated together. As such, a recipient 36 may respond by entering a command that acknowledges acceptance of the non-voice call 18. The voice telephone 34/text device 40 or video device 41 then generates and transmits the text/video link 38 to the server module 22. The recipient 36 may not be notified of the identification code 33 and the identification code 33 may be automatically inserted into the text/video link 38. As used herein, the term “automatically” signifies without human intervention. Of course, the system 10 may still notify the recipient 36 of the identification code 33 and have the user 36 manually enter the identification code 33.

The server module 22 receives the text/video link 38 and retrieves the non-voice call 18 held in the queue 30. The server module 22 then enables text or video communication between the user 14 and the recipient 36 through their respective devices 12, 40 and 13, 41. The users 14, 36 may have real-time text or video communication.

The recipient 36 may hang up the placeholder call 32 once the text/video link 38 has been sent and received. However, as explained below, leaving the placeholder call 32 in place for the duration of the communication may have advantages where the recipient 36 is a call agent in a call center. In either situation, at the conclusion of the communication, the user 14 and the recipient 36 will hang up any in-place calls.

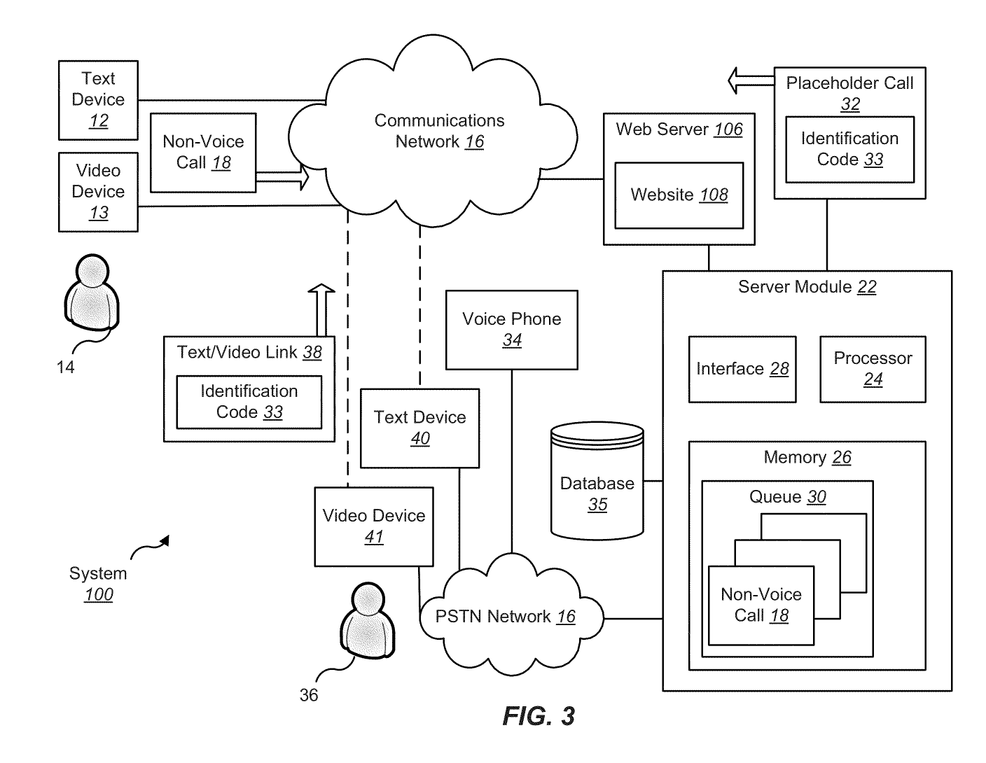

Referring to FIG. 3, an alternative embodiment of a system 100 is shown for use with the present invention. The system 100 is used with the Internet 102, and the text device 12 and video device 13 are capable of Internet communication. The text device 12 and video device 13 may be a personal computer with a browser, wireless device, alpha pager, cellular phone, or other Internet-enabled device. Thus, a user 14 may use an Internet-enabled device to call into a voice telephone or a voice-only call center.

The system 100 may include a webserver 106 that hosts a website 108. The text device 12 or and video device 13 communicates with the webserver 106 and receives a website 108 operated by an organization or individual. The user 14 is able to review a displayed webpage from a website 108. The webpage may include text, video or audio such as “click here to call the ABC call center” or similar language. A user 14 may select a link, icon, highlighted text, or other graphic displayed on the website 108 to initiate a non-voice call 18.

The website 108 may include information on the intended recipient such as the voice telephone number. When the user 14 selects a link displayed on the website 108, a connection is made between a browser and the webserver 106. This may be enabled by using, for example, a Java applet or similar control. The information as to the “ABC call center” organization, or its phone number, is then transmitted to the server module 22.

The webserver 106 may relay the non-voice call 18 and routing information, such as the organization name or voice telephone number to be called, to the server module 22. T he webserver 106 may communicate with the server module 22 across a network 16, Internet 102, or other systems known in the art. In the embodiment shown, the server module 22 communicates with the website 108 through an interface 28. Alternatively, the webserver 106 and the server module 22 may be integrated together. In one embodiment, the webserver 106 may be integrated with the server module 22.

The server module 22 receives the non-voice call 18 and routing information and places the non-voice call 18 in the queue 30. The server module 22 then generates a placeholder call 32 and sends the placeholder call 32 to a voice telephone 34 over a network 16, such as a PSTN. The destination number of the voice telephone 34 may be derived from the routing information. In one embodiment, a link selected on a website 108 corresponds to a destination number. The server module 22 may also access a database 35 to retrieve a destination number that is mapped to the selected link.

As in the previous embodiment, the placeholder call 32 may include an identification code 33 and text, audio or video instructions for the recipient 36. The recipient 36 may respond to the placeholder call 32 by generating a text/video link 38 through the text device 40 or video device 41. In one embodiment, the text device 40 or video device 41 may communicate over the PSTN network 16 to the server module 22.

The text device 40 or video device 41 may be Internet-enabled and communicates over the Internet 102 with the webserver 106. In many organizations and homes, a voice telephone 34 is disposed near an Internet-linked computer. The computer may be used to generate the text/video link 38 to the server module 22. The computer may have a browser for Internet-enabled text or video communication. Alternatively, an Internet chat program or video compatible program on the computer may be used. The text device 40 or video device 41 may also be embodied as any number of capable devices such as an alpha pager, PDA, cellular phone, or other Internet-enabled device. The identification code 33 may be included in the text/video link 38.

The webserver 106 interacts with the server module 22 to retrieve the non-voice call 18 held in the queue 30. The webserver 106 and server module 22 further interact to establish text communication between the users 14, 36 in a manner similar to that previously described.

In either embodiment, the recipient 36 may include the identification code 33 with the text/video link 38 by manually entering the identification code 33 into the text device 40 or video device 41. The identification code 33 is used to link the text/video link 38 with the non-voice call 18 held in the queue 30. Alternatively, the voice telephone 34 and the text device 40 or video device 41 may be integrated, and a recipient 36 may respond by entering an acceptance command. The voice telephone 34/text device 40 or video device 41 may then generate and transmit the text/video link 38 to the server module 22 or to the webserver 106.

The placeholder call 32 may include text, audio or video instructions that instruct the recipient 36 on how to establish a text/video link 38. For example, the placeholder call 32 may say “text call, please go to your company's text website, www.nexttalk.net, and enter the following identification code ‘123’” or similar instructions. The server module 22 may use the identification code “123” to match the text/video link 38 with the holding non-voice call 18.

The queue 30 may be mapped to the website 108 for this organization. Where the text device 40 or video device 41 is an Internet-enabled device, such as a personal computer with a browser, the recipient 36 accesses the website 108 and enters the identification code 33. The text/video link 38 is generated by an entry on the website 108. The webserver 106 transmits the entry to the server module 22 and the server module 22 matches the text/video link 38 with the non-voice call 18. In one implementation, the text/video link 38 is matched with the non-voice call 18 held in the queue 30 the longest, thereby removing the need for an identification code 33.

The voice telephone 34 may be in communication or integrated with the text device 40 or video device 41. As such, the text device 40 or video device 41 may retrieve the placeholder call 32. The text device 40 or video device 41 may recognize that the incoming caller is the server module 22. The text device 40 or video device 41 may then automatically launch a browser, as described above, to make a text call back to the server module 22. Automated steps may include all aspects of establishing a text communication, however, it is desirable to provide user intervention to determine if the non-voice call 18 is accepted. The recipient 36 answering the placeholder call 32 may also use an Internet chat or video application to create a text/video link 38 back to the server module 22.

In either of the embodiments described with respect to FIGS. 2 and 3, the recipient 36 may hang up the placeholder call 32 once the text/video link 38 has been received and text communication has been established. However, there are situations where leaving the placeholder call 32 in place for the duration of the text call is advantageous. One example is where the recipient 36 is a call agent in a call center, which is discussed below.

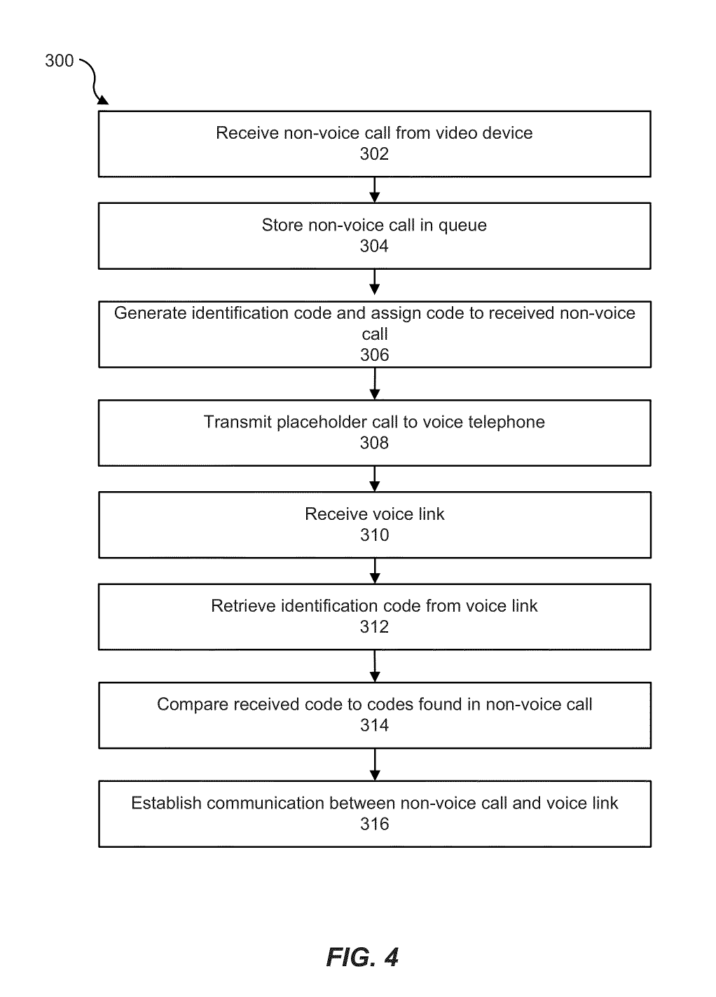

Referring to FIG. 4, a flow diagram is shown illustrating a method 300 performed using the server module 22. Instruction code resident on the memory 26 and executed by the processor 24 performs at least a portion of the method 300 described herein. The method 300 is generally applicable to the embodiments of FIGS. 2 and 3 and to other embodiments disclosed herein. Additional steps may be implemented, and the method shown is for illustrative purposes only.

The server module 22 receives the non-voice call 18 from the text device 12 or video device 13 in a step 302. The non-voice call 18 may be received from a PSTN network 16, from the Internet 102, or from another type of network. The non-voice call 18 may be sent directly through a phone number specific to the server module 22 or routed by the recipient 36. T he non-voice call 18 may be generated and received through, for example, a website, generated by email or by any number of Internet-enabled devices. The non-voice call 18 may be a text call or a video call as discussed above.

The non-voice call 18 is next stored in a queue 30, which is resident in the memory 26 in a step 304. Entry of the non-voice call 18 may be sequential. The server module 22 generates an identification code 33 and assigns the identification code 33 to the received non-voice call 18 in a step 306. The identification code 33 may be based on a number of features or information associated with the non-voice call 18. Alternatively, the identification code 33 may be time-based, randomly generated, or generated in some alternative manner.

The server module 22 then transmits a placeholder call 32 to the voice telephone 34 designated by the non-voice call 18 in a step 308. The placeholder call 32 includes the identification code 33. The server module 22 then receives a text/video link 38 through, for example, the PSTN network 16, Internet 102, or other type of network in a step 310. The server module 22 retrieves an identification code 33 from the text/video link 38 in a step 312. The server module 22 then compares the received identification code 33 to codes found in non-voice calls 18 stored in the queue 30 in a step 314. Upon a successful match, the server module 22 then establishes communication between the non-voice call 18 and the text/video link 38 in a step 316. Communication continues until disconnected by one of the parties.

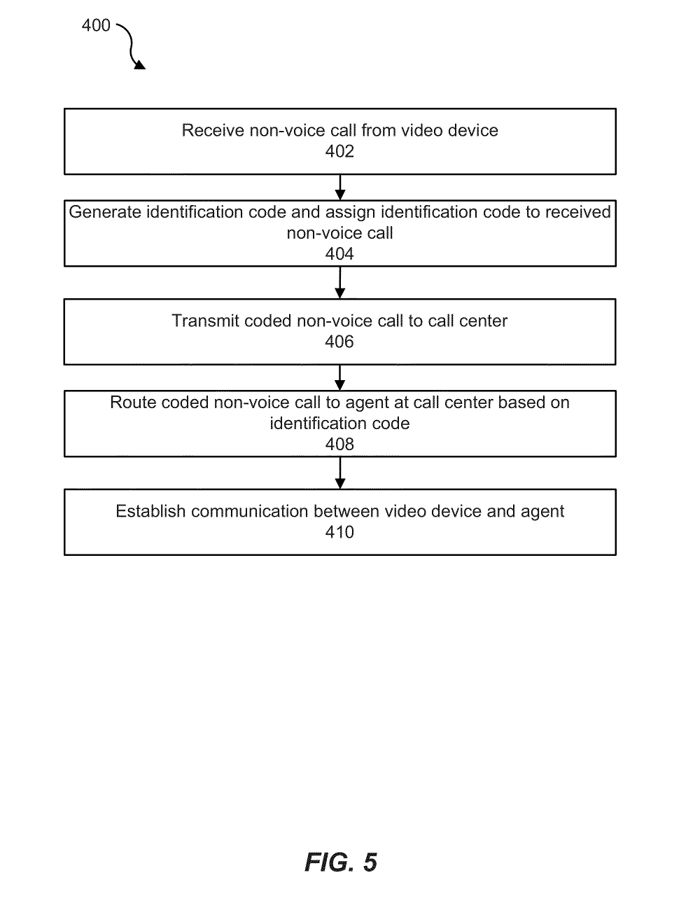

Referring to FIG. 5, a flow diagram is shown illustrating another method 400 performed using the server module 22. Instruction code resident on the memory 26 and executed by the processor 24 performs at least a portion of the method 400 described herein. The method 400 is generally applicable to both of the embodiments of FIGS. 2 and 3 and to other embodiments disclosed herein. Additional steps may be implemented, and the method shown is for illustrative purposes only.

The server module 22 receives the non-voice call 18 from the text device 12 or video device in a step 402. The non-voice call 18 may be received from a PSTN network 16, from the Internet 102, or from another type of network. The non-voice call 18 may be directly sent through a phone number specific to the server module 22 or routed by the recipient 36. The non-voice call 18 may be generated and received through, for example, a website, generated by email, or generated by any number of Internet-enabled devices. The non-voice call 18 may be, for example, a text call or a video call as discussed above.

The server module 22 generates an identification code 33 and assigns the identification code 33 to the received non-voice call 18 in a step 404. The identification code 33 may be based on any number of features or information associated with the non-voice call 18. Alternatively, the identification code 33 may be time-based, randomly generated, or generated in some alternative manner.

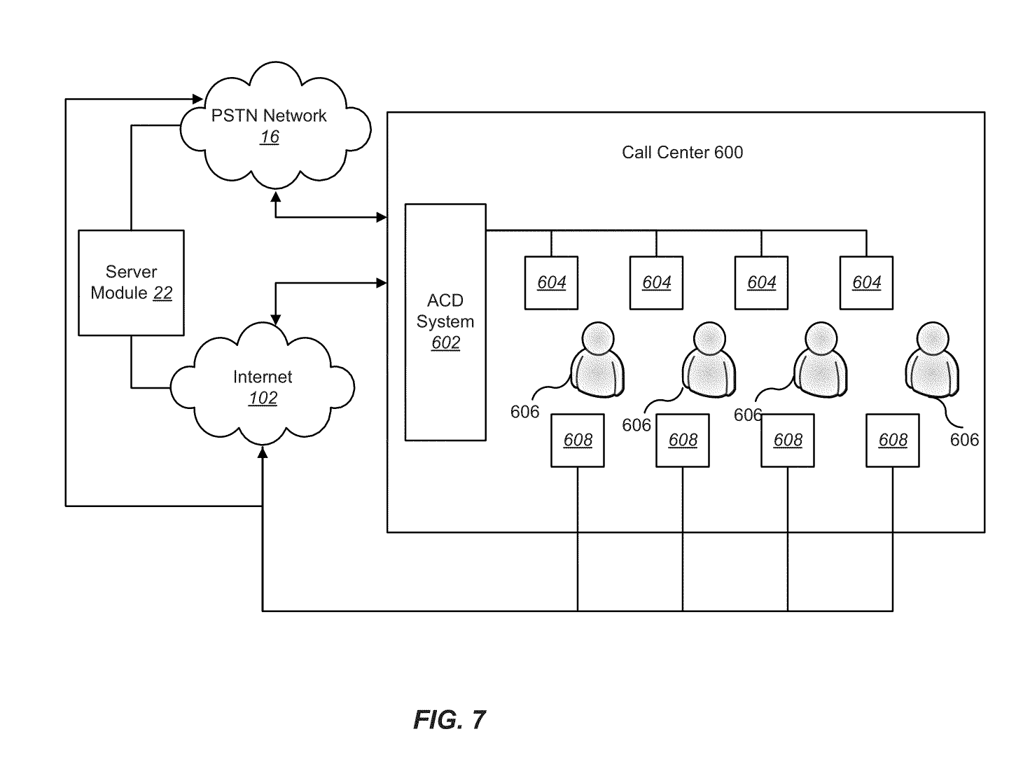

The server module 22 then transmits or links the non-voice call 18 to a call center through, for example, the PSTN network 16, Internet 102, or other type of network in a step 406. The call center may include features as described below related to call center 600 shown in FIG. 7. The coded non-voice call 18 is routed to an agent or recipient 36 at the call center in a step 408. The routing may be based at least in part on the coding applied to the non-text call 18. The coding may relate to, for example, a language or translation need associated with the non-text call 18.

The recipient 36 may have access to hardware such as the video device 41 that links with the coded non-voice call 18. Upon a successful link between the recipient 36 and the user 14, communication between the non-voice call 18 and the text/video link 38 is established in a step 410. Communication continues until disconnected by one of the parties.

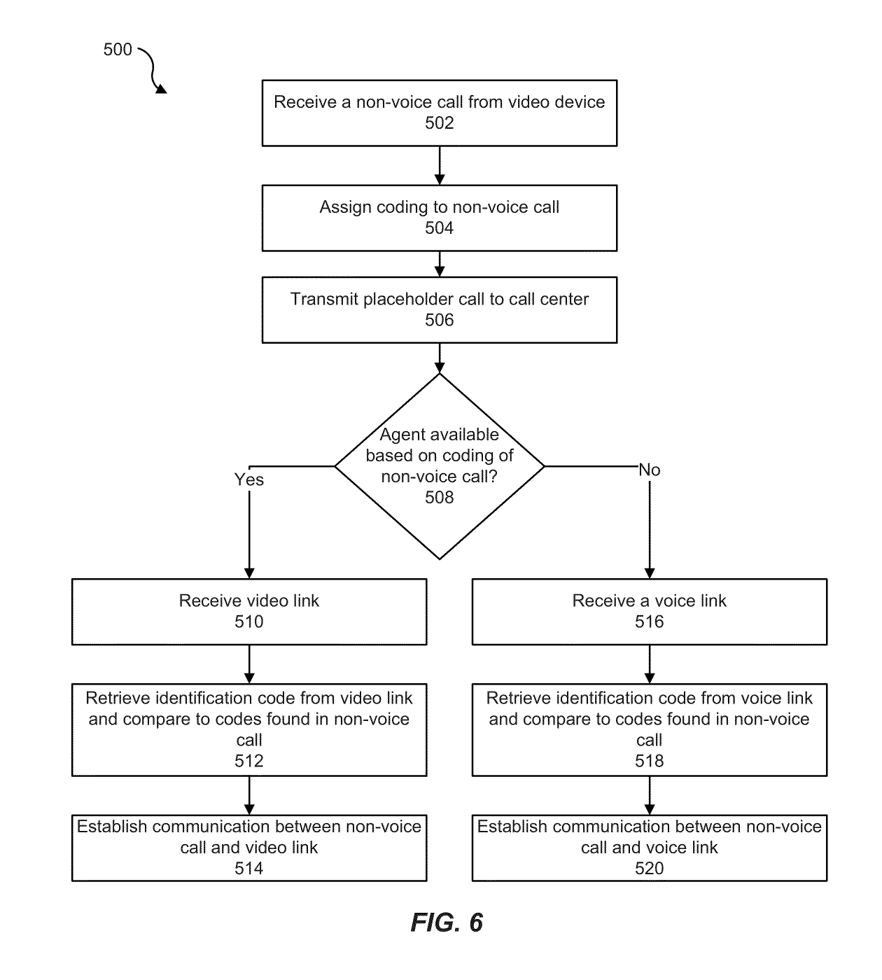

Referring to FIG. 6, a flow diagram is shown illustrating another method 500 performed using the server module 22. Instruction code resident on the memory 26 and executed by the processor 24 performs at least a portion of the method 500 described herein. The method 500 is generally applicable to both of the embodiments of FIGS. 2 and 3 and to other embodiments disclosed herein. Additional steps may be implemented, and the method shown is for illustrative purposes only.

The server module 22 receives the non-voice call 18 from the text device 12 or video device in a step 502. The non-voice call 18 may be received from a PSTN network 16, from the Internet 102, or from another type of network. The non-voice call 18 may be sent directly through a phone number specific to the server module 22 or routed by the recipient 36. The non-voice call 18 may be generated and received through, for example, a website, generated by email, or generated by any number of Internet-enabled devices. The non-voice call 18 may be, for example, a text call or a video call as discussed above.

The server module 22 assigns coding 33 to the received non-voice call 18 in a step 504. The coding 33 may be based on any number of features or information associated with the non-voice call 18. Alternatively, the identification code 33 may be time-based, randomly generated, or generated in some alternative manner.

The server module 22 then transmits a placeholder call 32 to the voice telephone 34 designated by the non-voice call 18 in a step 506. The placeholder call 32 includes the coding 33. The call center may include features as described below related to call center 600 shown in FIG. 7. The call center determines whether there is an agent available based on the coding 33 in a step 508. If an agent is available, server module 22 receives a video link 38 from the call center in a step 510. The coding 33 is retrieved from the video link and compared to the coding applied to the non-voice call in a step 512. Upon a successful match, the server module 22 then establishes communication between the non-voice call 18 and the video link 38 in a step 514. Communication continues until disconnected by one of the parties.

If an agent having video capability is not available in the step 508, the server module 22 may receive a voice link in a step 516. The server module 22 retrieves coding from the voice link and compares the coding to the coding applied to the non-voice call 18 in a step 518. Upon a successful match, the server module 22 then establishes communication between the non-voice call 18 and the voice link 38 in a step 520. Communication continues using the audio component of the non-voice call 18 and the voice capability of the agent until disconnected by one of the parties.

Referring to FIG. 7, a block diagram illustrating a call center 600, which is in communication with a PSTN network 16 and the Internet 102, is shown. The call center 600 includes an automated call distribution (ACD) system 602, which couples with voice telephones 604 and that are operated by call agents 606. The ACD system 602 routes voice calls to the different voice telephones 604 as the telephones become available. The ACD system 602 may be embodied as a computer operating a computer telephony integration (CTI) which is an application that enables the computer to operate as a call center. The ACD system 602 is typically designed for voice calls and not text or video calls. The ACD system 602 may maintain call statistics and track the time that each call agent 606 spends on calls versus idle time.

If a non-voice call is sent to a call agent 606, it is desirable to create some type of integration with the ACD system 602. If the ACD system 602 is not aware that a call agent 606 is busy on a non-voice call, then the ACD system 602 may send a voice call to this same call agent 606. Similarly, the call agent's time spent on non-voice calls may not be tracked by the ACD system 602 without integration. However, creating communication links and integrating with the ACD system 602 to handle non-voice calls is often expensive and difficult.

The systems and methods of the present disclosure offer a much simpler approach than an ACD integration approach. When the server module 22 described above sends a placeholder call 32 to the call center 600, the placeholder call 32 may sit in a queue of the ACD system 602 for some period. During the hold period, the server module 22 may send “please hold” messages back to the text device 12 or video device 13 that originate the incoming non-voice call 18.

Once the placeholder call 32 is routed by the ACD system 602 to a call agent 606, then the call agent 606 creates a text/video link 38 back to the server module 22 to link to the holding non-voice call 18. A text or video device 608 may be placed adjacent to the call agents 606 to enable text communication. The text or video devices 608 may be similarly embodied as the devices 12, 40, 41 previously described. Thus, a text or video device 608 may be Internet-enabled or capable of communication across a PSTN network.

After receiving a placeholder call 32, the call agent 606 retains connection with the placeholder call 32. For the ACD system 602, the placeholder call 32 is treated as the actual call so it knows that this call agent 606 is busy. The

ACD system 602 will not send a new voice call to this call agent 606. Once the text communication is completed, the call agent 606 hangs up the text/video link 38 and the placeholder call 32. The ACD system 602 then tracks the amount of time this call agent spent on the non-voice call based on the time of the placeholder call 32. The ACD system 602 is then free to send new incoming voice calls to this call agent 606.

In one implementation, the ACD system 602 receives an incoming placeholder call 32 and retrieves and records the identification code 33. The identification code 33 may represent information about incoming non-voice call 18. The ACD system 602 sends the placeholder call 32 to a voice telephone 604. The ACD system 602 further accesses a memory or database, which may be resident within the ACD system 602, to locate a text or video device 608 assigned to the voice telephone 604 receiving the placeholder call 32. The assigned text or video device 608 may be proximate to the voice telephone 604 to allow use by a call agent 606.

The ACD system 602 generates a text/video link 38 and includes the identification code 33. The text/video link 38 is sent to the server module 22 where the text/video link 38 is matched to the non-voice call 18 as previously discussed. The ACD system 602 may be coupled with the text or video devices 608 to enable communication. Once the text-based communication is enabled, the ACD system 602 contacts the assigned text or video device 608. The assigned text or video device 608 then participates in the text- or video-based communication.

In another method, the ACD system 602 does not generate a text/video identification code 33, but is coupled to the text or video devices 608. Upon transmitting a placeholder call 32 to a voice telephone 604, the ACD system 602 contacts the corresponding text or video device 608. The ACD system 602 then transmits the identification code 33 to the text or video device 608. The text or video device 608 may automatically (e.g., without user intervention) generate a text/video link 38 with the identification code 33 included. The text/video link 38 may be transmitted to the server module 22 where text- or video-based communication is established between devices 12, 608 or 13, 608.

The foregoing methods require little or no user intervention by a call agent 606. A call agent 604 is notified of the non-voice call 18 by the placeholder call 32. The call agent 606 may then turn to a corresponding text or video device 608. Text- or video-based communication may be enabled with the text or video device 608 without the call agent 606 entering an identification code 33. The call agent 606 may then participate in a communication. As before, the call agent 606 may retain connection with the placeholder call 32 for determining the call length.

Alternatively, the ACD system 602 may monitor the length of the conversation through communication with the text or video device 608. In such an implementation, the call agent 606 may not need to retain the connection with the placeholder call 32.

In some situations, a user 14 may be able to vocalize speech, but be unable to see or hear. It would be advantageous to provide audio or video to a recipient 36 or call agent 606 and enable appropriate text or video responses.

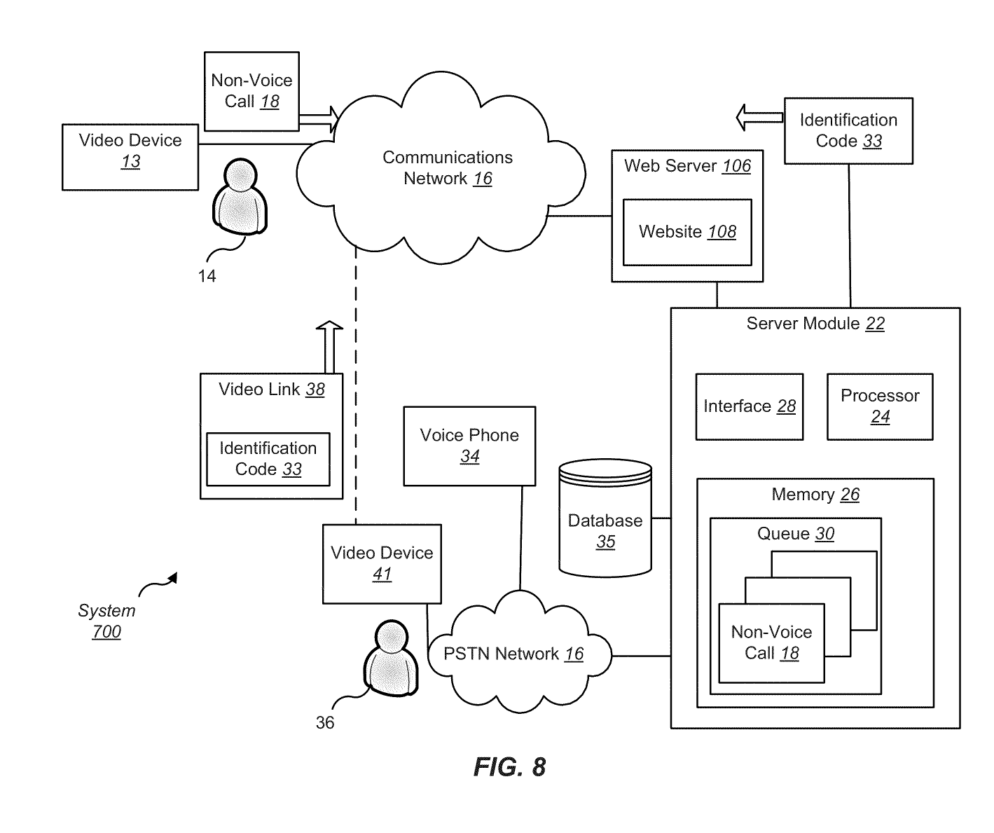

Referring to FIG. 8, an alternative system 700 is shown wherein an originating non-voice call 18 includes a video call, which conveys video and audio content from the user 14. The server module 22 may receive the non-voice call 18, identify and codes the non-voice call 18, and hold the non-voice call 18 in the queue 30. The server module 22 may confirm availability of a recipient 36 based on an identification code 33 associated with the non-voice call 18. The server module 22 may link a video device 41 of the recipient with a video device 13 of the user 14 using, for example, the communications network 16 via a web server 106 and website 108, or through a PSTN network 16. Once the link between the user 14 and recipient 36 is confirmed, the parties may carry on video communicate. The communication may or may not include audio.

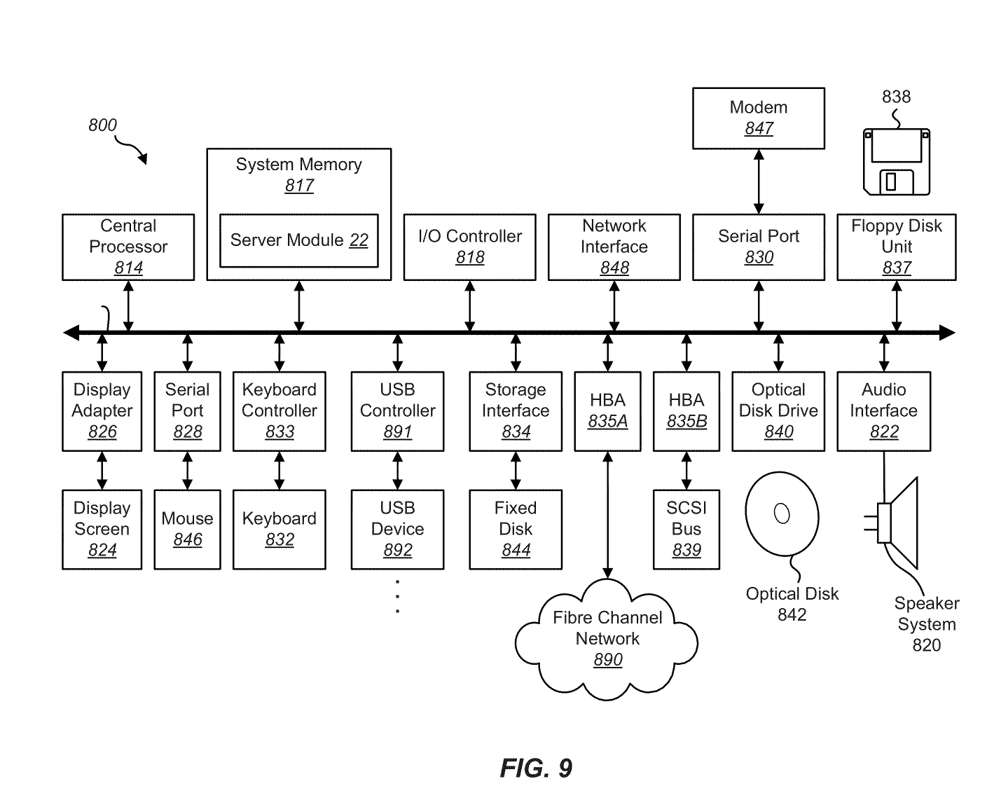

FIG. 9 depicts a block diagram of a computer system 810 suitable for implementing the present systems and methods. Computer system 810 includes a bus 812 which interconnects major subsystems of computer system 810, such as a central processor 814, a system memory 817 (typically RAM, but which may also include ROM, flash RAM, or the like), an input/output controller 818, an external audio device, such as a speaker system 820 via an audio output interface 822, an external device, such as a display screen 824 via display adapter 826, serial ports 828 and 830, a keyboard 832 (interfaced with a keyboard controller 833), multiple USB devices 892 (interfaced with a USB controller 890), a storage interface 834, a floppy disk drive 837 operative to receive a floppy disk 838, a host bus adapter (HBA) interface card 835A operative to connect with a Fibre Channel network 890, a host bus adapter (HBA) interface card 835B operative to connect to a SCSI bus 839, and an optical disk drive 840 operative to receive an optical disk 842. Also included are a mouse 846 (or other point-and-click device, coupled to bus 812 via serial port 828), a modem 847 (coupled to bus 812 via serial port 830), and a network interface 848 (coupled directly to bus 812).

Bus 812 allows data communication between central processor 814 and system memory 817, which may include read-only memory (ROM) or flash memory (neither shown), and random access memory (RAM) (not shown), as previously noted. The RAM is generally the main memory into which the operating system and application programs are loaded. The ROM or flash memory may contain, among other code, the Basic Input-Output system (BIOS) which controls basic hardware operation such as the interaction with peripheral components or devices. For example, the server module 22 to implement the present systems and methods may be stored within the system memory 817. Applications resident with computer system 810 are generally stored on and accessed via a computer readable medium, such as a hard disk drive (e.g., fixed disk 844), an optical drive (e.g., optical drive 840), a floppy disk unit 837, or other storage medium. Additionally, applications may be in the form of electronic signals modulated in accordance with the application and data communication technology when accessed via network modem 847 or interface 848.

Storage interface 834, as with the other storage interfaces of computer system 810, may connect to a standard computer readable medium for storage and/or retrieval of information, such as a fixed disk drive 844. Fixed disk drive 844 may be a part of computer system 810 or may be separate and accessed through other interface systems. Modem 847 may provide a direct connection to a remote server via a telephone link or to the Internet via an Internet service provider (ISP). Network interface 848 may provide a direct connection to a remote server via a direct network link to the Internet via a POP (point of presence). Network interface 848 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present systems and methods. The devices and subsystems may be interconnected in different ways from that shown in FIG. 9. The operation of a computer system such as that shown in FIG. 9 is readily known in the art and is not discussed in detail in this application. Code to implement the present disclosure may be stored in computer-readable medium such as one or more of system memory 817, fixed disk 844, optical disk 842, or floppy disk 838. The operating system provided on computer system 810 may be MS-DOS®, MS-WINDOWS®, OS/2®, UNIX®, Linux®, or another known operating system.

Moreover, regarding the signals described herein, those skilled in the art will recognize that a signal may be directly transmitted from a first block to a second block, or a signal may be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

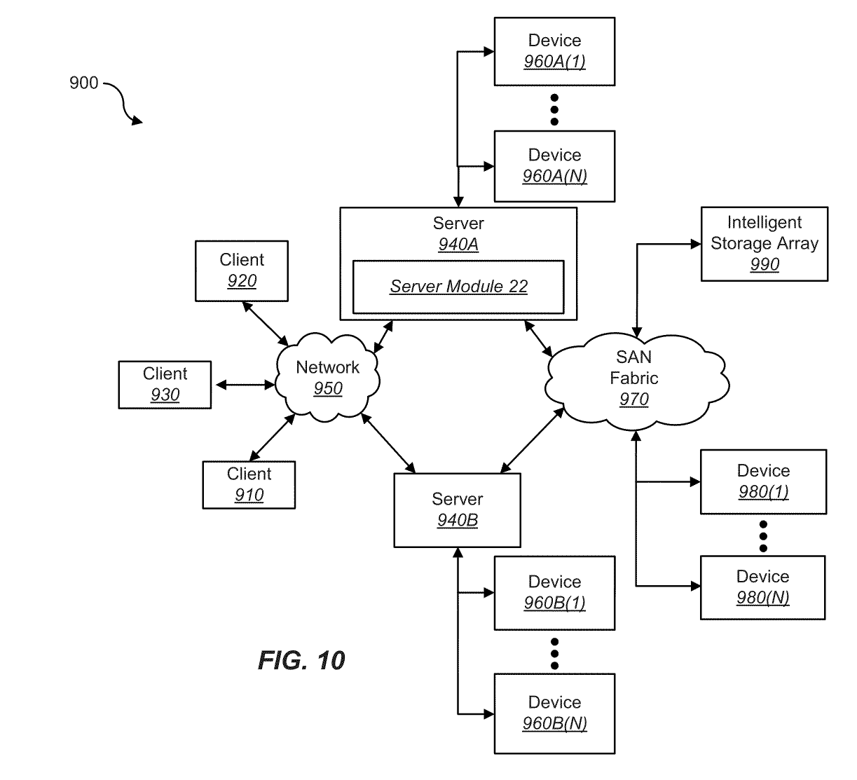

FIG. 10 is a block diagram depicting a network architecture 900 in which client systems 910, 920 and 930, as well as storage servers 940A and 940B (any of which may be implemented using computer system 910), are coupled to a network 950. In one embodiment, the server module 22 may be located within a server 940A, 940B to implement the present systems and methods. The storage server 940A is further depicted as having storage devices 960A(1)-(N) directly attached, and storage server 940B is depicted with storage devices 960B(1)-(N) directly attached. SAN fabric 970 supports access to storage devices 980(1)-(N) by storage servers 940A and 940B, and so by client systems 910, 920 and 930 via network 950. Intelligent storage array 990 is also shown as an example of a specific storage device accessible via SAN fabric 970.

With reference to computer system 810, modem 847, network interface 848 or some other method may be used to provide connectivity from each of client computer systems 910, 920, and 930 to network 950. Client systems 910, 920, and 930 are able to access information on storage server 940A or 940B using, for example, a web browser or other client software (not shown). Such a client allows client systems 910, 920, and 930 to access data hosted by storage server 940A or 940B or one of storage devices 960A(1)-(N), 960B(1)-(N), 980(1)-(N) or intelligent storage array 990. FIG. 10 depicts the use of a network such as the Internet for exchanging data, but the present systems and methods are not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

The process parameters and sequence of steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A method for providing video-based communication between an originating user and a recipient located within a call center, the method comprising:
a server receiving an originating live video call;
the server holding the live video call;
the server generating a placeholder call corresponding to the live video call, wherein the placeholder call is a voice call;
the server transmitting the placeholder call through a network to the call center;
the call center transmitting the placeholder call to a voice telephone to notify a recipient of the live video call;
generating a unique user code that identifies the recipient;
the server receiving the user code;
the server sending the live video call to the recipient based on the user code to establish communication.

2. The method of claim 1, wherein the user code is based at least in part on a skill set of the recipient.

3. The method of claim 2, wherein the skill set includes a non-English language.

4. The method of claim 1, wherein the recipient generates the user code.

5. The method of claim 1, wherein the call center generates the user code.

6. The method of claim 1, wherein the user code is based at least in part on video call equipment available to the recipient.

7. The method of claim 1, further comprising the recipient answering the placeholder call and confirming availability to receive the live video call.

8. The method of claim 1, wherein the call center includes a controller that routes calls to recipient employees of the call center, and the controller generates the user code.

9. A method for providing video-based communication between an originating user and a recipient located within a call center, the method comprising:
a server receiving an originating live video call;
the server holding the live video call;
the server generating a placeholder call corresponding to the live video call;
the server transmitting the placeholder call through a network to the call center;
the call center determining if an agent with video call capability is available;
if an agent with video call capability is available, the call center transmitting the placeholder call to the available agent within the call center;
the placeholder call passing a code for the live video call to a computer interface of the agent;
the computer interface using the code to retrieve the live video call from the server;
the server establishing communication with the agent.

10. The method of claim 9, wherein the computer interface comprises a software program operated on a computer.

11. The method of claim 9, further comprising the call center engaging a video device to receive communication.

12. The method of claim 9, wherein if an agent with video call capability is not available, the call center transmitting the placeholder call to a voice phone, and the call center generating a voice link and transmitting the voice link to the server.

13. The method of claim 9, wherein if an agent with video call capability is not available, the call center placing the live video call in a queue until an agent with video call capability becomes available.

14. A method of routing non-voice communication within a call center, comprising:
receiving an incoming non-voice call;
coding the non-voice call with coding representing at least one of a text communication, a video communication, and a language;
communicating the coded non-voice call to the call center;
routing the coded non-voice call to an agent of the call center based on the coding.

15. The method of claim 14, wherein the non-voice call is a video call and the coding represents a language to be translated by an agent of the call center.

16. The method of claim 14, further comprising generating a placeholder call that represents the coded non-voice call.

17. The method of claim 14, further comprising determining if the call center has an agent available to take the coded non-voice call.

18. The method of claim 17, wherein determining if a call center has an agent available includes determining if an agent having video call capability is available.

19. The method of claim 14, wherein the non-voice call is a video call, the method further comprising determining if the call center has an agent available for the video call, and if not, creating a voice call link between the video call and an agent of the call center.

20. The method of claim 14, wherein the coding representing both video communication and a language.
